(19) United States
(12) Patent Application Publication
(10) Pub. No.: US 2024/0280254 A1
(43) Pub. Date: Aug. 22, 2024

(54) Interactive Flag Display Device

(71) Applicant: Michele Plotts, Woodstock, GA (US)

(72) Inventor: Michele Plotts, Woodstock, GA (US)

(21) Appl. No.: 18/407,843

(22) Filed: Jan. 9, 2024

Related U.S. Application Data
(60) Provisional application No. 63/446,491, filed on Feb. 17, 2023.

(51) Int. Cl. F21V 33/00; A63H 5/00; A63H 29/22

(52) U.S. Cl. CPC F21V 33/008; A63H 5/00; A63H 29/22

(57) ABSTRACT

This present invention relates to an interactive patriotic toy. The toy includes an ergonomic handle, a flag member made of fabric or plastic with no sharp elements, the flag member is coupled to a rotating member, and the rotating member functions as a flag post. The toy includes a plurality of LEDs for flag illumination, a speaker for playing patriotic music, and a motor for flag rotation. A light button actuates the plurality of LEDs, a sound (i.e., audio) button activates the speaker, and a waving/rotating button activates the rotation of the flag member and waving of the flag. The toy also has an embedded microcontroller, further enhancing the play experience. In one embodiment, the flag member is adapted to represent flags of different countries, states, events, and sports teams.

### CROSS-REFERENCE TO RELATED APPLICATION

The present application claims priority to, and the benefit of, U.S. Provisional Application No. 63/446,491, which was filed on Feb. 17, 2023, and is incorporated herein by reference in its entirety.

### FIELD OF THE INVENTION

The present invention generally relates to the field of interactive toys for children/toddlers. More specifically, the present invention relates to a novel toy for children and is configured similar to a miniature patriotic flag. The toy includes a handle which is wider to be safer for children and features a light actuation button and a sound (i.e., audio) actuation button. A waving button is disposed for rotating and waving the flag. The flag toy can be adapted to any country's or sports team's flag and music. The toy can play an anthem and display the flag of the country whose anthem is played by the speaker. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals often enjoy attending different patriotic and sports events such as parades and athletic events with their children. Such events are typically festive and can be a source of excitement and entertainment for families. Parades and other national events also instill patriotic feelings in individuals. Individuals often wave flags and other novelty items as a way to show their support or enthusiasm for a particular cause, team, or country. Waving such items is a common tradition at many events, adding to the festive atmosphere.

However, flags and other similar items have sharp or pointy features, such as the top of miniature flagpoles. The sharp features can pose a danger to children. The sharp elements can potentially cause injuries to a child's or toddler's eyes, nose, and ears, making them a potential hazard when handled by young children. Often, flags and other novelty items are thrown away after use. This not only results in waste but is also disrespectful, especially when the flags represent a country or a symbol of importance. Traditional flags are also not adaptable or reusable. For example, for supporting different teams, individuals need to purchase separate flags for different teams. Given the safety concerns, potential disrespect, and lack of adaptability, individuals desire an improved flag device that can serve as a toy for toddlers while being adaptable to represent different countries or different teams.

Therefore, there exists a long-felt need in the art for a patriotic toddler toy that represents a flag without any sharp or pointed features. Additionally, there is a long-felt need in the art for a toddler toy that is in the shape of a flag and functions as an interactive and engaging toy. Moreover, there is a long-felt need in the art for a novel interactive, and engaging toy that not only represents a flag but also offers features such as sound (i.e., audio), illumination, and rotation, thereby making the toy a source of entertainment for toddlers and others holding the toy source. Further, there is a long-felt need in the art for a versatile and reusable toddler toy that can be customized to match the theme or event, making the toy suitable for a wide range of audiences and occasions. Furthermore, there is a long-felt need in the art for a patriotic toddler toy that is a safe alternative to conventional flags and novelty items that children can interact with without the risk of injury to their eyes, nose, or ears. Also, there is a long-felt need in the art for a patriotic toy that is in the form of a modified flag toy for small children with a wider base for safe, easy, and convenient waving. Finally, there is a long-felt need in the art for a fun and unique toy for children to use at different types of patriotic events and which is safe to use and carry.

The subject matter disclosed and claimed herein, in one embodiment thereof, comprises a handheld toddler toy. The toy represents a flag and is easy and convenient to handle and play. The toy includes a flag member rotatably coupled to a handle using a rotating member, the flag member is made of fabric or plastic with no pointed or sharp ends and edges, a plurality of LEDs are disposed within the flag member, a light button is disposed on the handle for illuminating the LEDs in various colors to adapt the flag member to represent different flags, a sound (i.e., audio) button is disposed for activating a speaker to play patriotic songs and a waving button for rotating the flag member 360 degrees and for waving the flag member. The patriotic song or team cheer can be played by the speaker which is associated with the flag represented by the flag member.

In this manner, the handheld patriotic toddler toy of the present invention accomplishes all of the foregoing objectives and provides users with a safe alternative to conventional flags that children and others can interact with without the risk of injury to their eyes, nose, or ears. The toy provides a respectful way of celebrating patriotism and events. The toy is interactive and engaging for children. Further, the toy incorporates music, rotating motion, and colorful lighting to create an entertaining and educational experience for young users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld toddler toy. The toy further comprising a flag member rotatably coupled to a handle using a rotating member, the flag member is made of fabric or plastic with no pointed ends, a plurality of LEDs are disposed within the flag member, a light button for illuminating the LEDs in various colors to represent flags, a sound (i.e., audio) button for activating a speaker to play patriotic songs and a waving button for rotating the flag member 360 degrees and waving the flag.

In a further embodiment of the present invention, a patriotic toddler toy is disclosed. The patriotic toddler toy includes a handle with grip lines for holding the toy, a flag member adapted to represent the flag of a country or a team, the flag member is connected to a rotating member, and the rotating member is rotatably coupled to the handle. A plurality of LEDs is disposed in the flag member for illumination to represent the flag of a country or a team. A motor embedded in the handle is used for providing rotational force to the rotating member, a memory is adapted to store songs and music to be played out by a speaker, a power button activates and deactivates the toy, and a power source provides electrical power to the speaker and the LEDs.

In yet another embodiment, a versatile toddler patriotic toy is disclosed. The toy includes a handle for holding the toy, the handle including a plurality of grip lines to activate the sensory skills of a toddler, a flag member adapted to represent flags of different countries or sports teams, a memory configured to store a plurality of songs, and LED patterns, each song is associated with an LED pattern and a unique identifier, wherein a microcontroller upon receiving an identifier, retrieves the song and the LED pattern corresponding to the received identifier from the memory. The song is played out by a speaker of the toy and the LEDs disposed in the flag member are illuminated in the retrieved LED pattern to represent the flag of the country or team identified by the received identifier.

In another aspect, the handle is made of plastic, wood, lightweight metal, or any other similar durable and lightweight material.

In yet another embodiment, the flag member is rotated 360 degrees when the waving button is pressed once and the flag member is waved when the waving button is pressed twice in succession.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the patriotic toddler toy of the present invention in accordance with the disclosed structure;

FIG. 2 illustrates a functional block diagram depicting electronic components included in the patriotic toddler toy of the present invention in accordance with the disclosed structure;

FIG. 3 illustrates a flow chart depicting a process of adaptability of the patriotic toddler toy of the present invention for representing flags of different countries in accordance with one embodiment of the present invention; and

FIG. 4 illustrates a cross-sectional view of one embodiment of the flag member used in the patriotic toddler toy of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a patriotic toddler toy that represents a flag without any sharp or pointed features. Additionally, there is a long-felt need in the art for a toddler toy that is in the shape of a flag and functions as an interactive and engaging toy. Moreover, there is a long-felt need in the art for a novel interactive, and engaging toy that not only represents a flag but also offers features like sound (i.e., audio), illumination, and rotation, making the toy a source of entertainment for toddlers. Further, there is a long-felt need in the art for a versatile and reusable toddler toy that can be customized to match the country flag, state flag, theme, or event, making the toy suitable for a wide range of audiences and occasions. Furthermore, there is a long-felt need in the art for a patriotic toddler toy that is a safe alternative to conventional flags and novelty items that children can interact with without the risk of injury to their eyes, nose, or ears. Also, there is a long-felt need in the art for a patriotic toy that is in the form of a modified flag toy for small children with a wider base for safe, easy, and convenient waving. Finally, there is a long-felt need in the art for a fun and unique toy for children to use at different types of patriotic events which is safe to use and carry.

The present invention, in one exemplary embodiment, is a patriotic toddler toy. The patriotic toddler toy includes a handle with grip lines for holding the toy, a flag member adapted to represent flag of a country or a team, the flag member is connected to a rotating member, and the rotating member is rotatably coupled to the handle. A plurality of LEDs is disposed in the flag member for illumination to represent the flag of a country, state, event, or a team. A motor embedded in the handle is used for providing rotational force to the rotating member, a memory is adapted to store songs and music to be played out by a speaker, a power button activates and deactivates the toy, and a power source provides electrical power to the speaker and the LEDs.

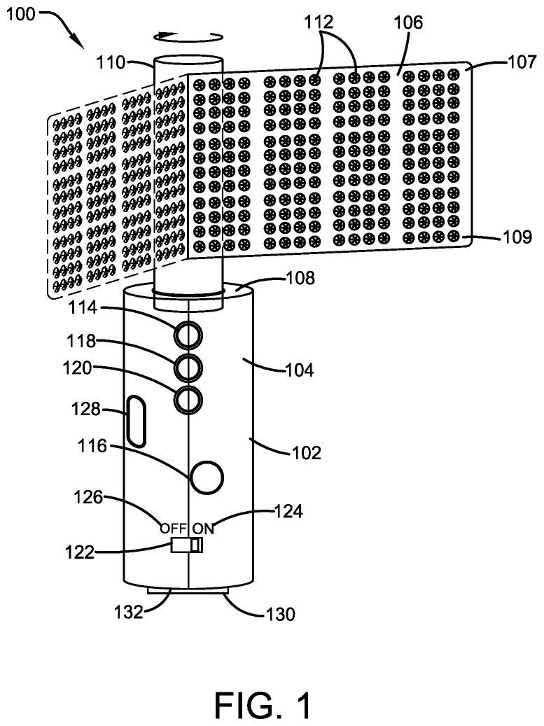

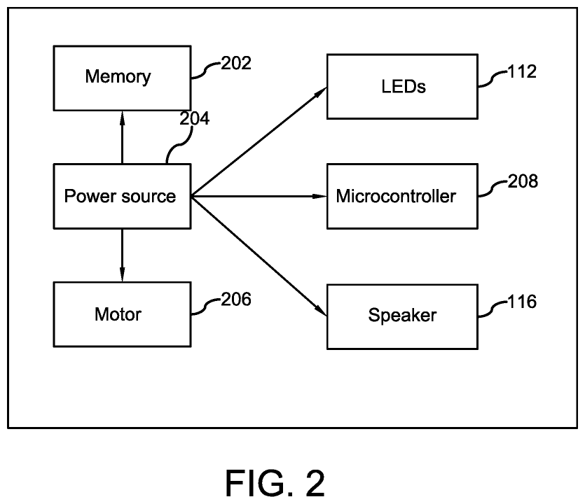

Referring initially to the drawings, FIG. 1 illustrates a perspective view of one potential embodiment of the patriotic children's toy of the present invention in accordance with the disclosed structure. The interactive patriotic flag toy or flag display device 100 is designed in the form of a miniature patriotic flag that can be held in a hand by individuals of all ages. The patriotic toy 100 helps to keep a child engaged and entertained while also promoting a sense of patriotism or team spirit. More specifically, the children's flag toy 100 includes an ergonomic handle 102 having gripping lines 104 positioned on the outer surface of the handle 102. The handle 102 is preferably cylindrical but can be of any geometrical shape and encloses a plurality of electronic components as described in FIG. 2. The handle 102 is made of plastic, wood, lightweight metal, or any other similar durable and lightweight material. The handle 102 is preferably from 1 inch to 3 inches in diameter and 2 inches to 8 inches in height.

A flag member 106 is rotatably coupled to the top end 108 of the handle 102 using a rotating member 110. The flag member 106 is made up of a fabric or plastic and includes curved ends 107, 109, thereby enabling easy and safe handling of the toy 100 by a young child. The flag member 106 may have a design of a country's/state's flag or a sports team's flag to meet the requirements of different users. The flag member 106 has a plurality of LEDs 112 disposed therein that are selectively illuminated in different colors to illuminate the flag member 106. The rotating member 110 also functions as a hoist for waving the flag member 106.

A plurality of buttons is positioned on the handle 102 and are configured to activate illumination and sound (i.e., audio) in the interactive patriotic flag toy 100. The buttons can be physical buttons or soft buttons depending on the manufacturing requirements of the toy 100. A light button 114 is adapted to illuminate the LEDs 112 to illuminate the flag member 106 in a specific and selectable combination and pattern of colors to represent the desired flag of a country, state, team, event, and similar. The handle 102 has an embedded speaker 116 for playing out a patriotic song such as the national anthem of the country whose flag is displayed by the flag member 106. The song is played out upon actuation of a sound (i.e., audio) button 118 disposed on the handle 102.

A waving/rotation button 120 is disposed on the handle 102 and is used for rotating and waving the flag member 106. When the waving/rotation button 120 is pressed once, the rotating member 110 rotates 360 degrees to rotate the flag member 106. Also, when the waving/rotation button 120 is pressed twice in succession, the rotating member 110 functions as a hoist to create waves in the flag member 106. For activating and deactivating the LEDs 112, speaker 116, and the movement of the rotating member 110, a power sliding button 122 is provided in the handle 102. The button 112 when points to the “ON” position 124, activates the patriotic children's toy 100, and when points to the “OFF” position 126, deactivates the patriotic children's toy 100.

The flag member 106, the rotating member 110, and the handle 102 do not contain any pointed or sharp edges or features, therefore, can be easily and safely used by young children. Further, the toy 100 is washable and comes in different colors, designs, and sizes. The toy 100 can be adapted to represent the flag of any country, state, event, or even different sports teams. This adaptability makes the toy 100 suitable for a wide variety of audiences and occasions. Further, the choice of flag and accompanying music or sound (i.e., audio)s can be tailored to match the theme, event, or preferences of the child or parent. The children's toy 100 can be made of plastic and is easy to clean and can withstand rough handling. The flag member 106 can be made of fabric or plastic and can be designed to improve the sensory development of toddlers.

FIG. 2 illustrates a functional block diagram depicting electronic components included in the patriotic toddler toy of the present invention in accordance with the disclosed structure. The patriotic toy 100 includes a memory 202 configured to store different songs, music, and more. The music or songs stored in the memory 202 are played out by the speaker 116 upon actuation of the sound (i.e., audio) button 118. The memory 202 can be a volatile or non-volatile memory and preferably is flash memory or Electrically Erasable Programmable Read-Only Memory (EEPROM). A power source 204, preferably in the form of rechargeable batteries is included in the handle 102 for providing electric power to different electronic components included in the toy 100. The power source 204 is rechargeable and can also be recharged using solar energy.

A motor 206 is included in the handle 102 for providing rotating force or torque to the rotating member 110. When the waving/rotation button 120 is actuated by a user, the motor 206 is activated for enabling rotation of the handle 102 to rotate the flag member 360 degrees. The motor 206 runs on the electrical power provided by the power source 204 and can be in the form of a miniature motor. The motor 206 is preferably a DC motor and can be controlled to adjust the rotating speed of the rotating member 110 and the connected flag member 106. In some embodiments, the rotating member 110 can be rotated from 0.5 rotations per second to 10 rotations per second.

A microcontroller 208 is the monitoring module of the patriotic toy 100. The microcontroller 208 provides instructions to the different electronic components of the toy 100 and can be in the form of an integrated chip. The LEDs 112 are automatically activated upon actuation of the light button 114 wherein the microcontroller 208 activates the LEDs 112. The LEDs 112 are multicolored and can illuminate in a specific combination of colors to represent flags of different countries, states, teams, events, and more.

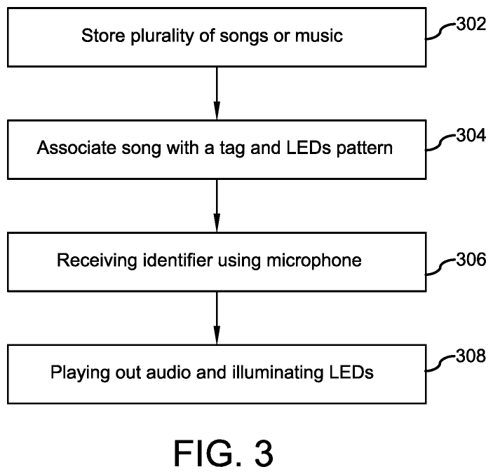

FIG. 3 illustrates a flow chart depicting a process of adaptability of the patriotic toy of the present invention for representing flags of different countries in accordance with one embodiment of the present invention. Initially, a plurality of songs or music is stored in the internal memory of the toy (Step 302). Each song or music audio is tagged with a unique keyword such as a country name or team name to uniquely identify the stored song. Then, along with each song or audio, a pattern of the LEDs illumination including specific color combinations to represent a flag is stored in the memory (Step 304). It will be apparent to a person skilled in the art that the tagging of each song and association of the LEDs pattern can be done during the manufacturing of the children's toy 100.

In the next step 306, an identifier is received from a user of the toy. Then, in step 308, based on the received identifier, the microcontroller 208 retrieves the corresponding audio and LEDs configuration pattern from the memory 202. Finally, in step 310, the retrieved audio is played through the speaker 116, and the LEDs are illuminated in the retrieved patterns and colors to adapt the adaptable toddler toy 100 to a specific country or team.

It should be noted that in some embodiments of the present invention, the toy 100 is designed to represent the flag of a single country or team and is not configured to be adapted for different countries and teams.

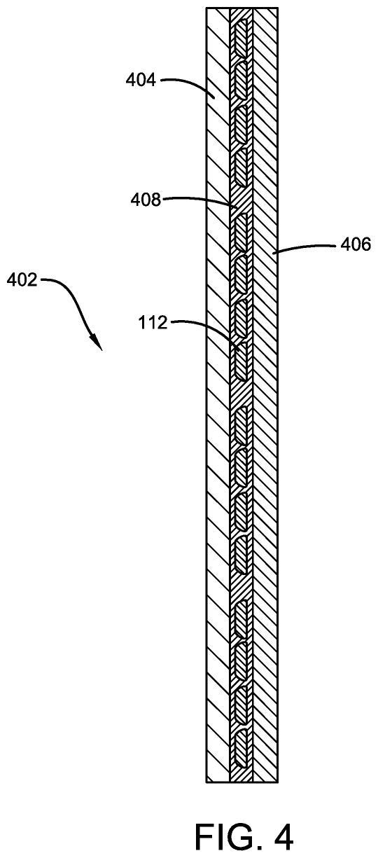

FIG. 4 illustrates a cross-sectional view of one embodiment of the flag member used in the patriotic toy of the present invention in accordance with the disclosed structure. In the present embodiment, the flag member 402 includes a first layer 404 of fabric and a second layer 406 made of the same or different fabric. An LED layer 408 including the plurality of LEDs 112 is disposed between the layers 404, 406. The LEDs illuminate in a specific combination, color, and pattern to represent the flag of a country or team.

In one embodiment of the present invention, the toy 100 can be controlled and operated by using a remote module device (not shown). Accordingly, a plurality of the toys can be centrally controlled in events like a ceremony, sports event, and more.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “interactive patriotic flag toy”, “patriotic toddler toy”, “flag display device”, “children's toy”, “patriotic toy”, and “toy” are interchangeable and refer to the interactive patriotic flag toy 100 of the present invention.

Notwithstanding the foregoing, the interactive patriotic flag toy 100 of the present invention can be of any suitable size and configuration as is known in the art without affecting the overall concept of the invention, provided that it accomplishes the above-stated objectives. One of ordinary skill in the art will appreciate that the interactive patriotic flag toy 100 as shown in the FIGS. is for illustrative purposes only, and that many other sizes and shapes of the interactive patriotic flag toy 100 are well within the scope of the present disclosure. Although the dimensions of the interactive patriotic flag toy 100 are important design parameters for user convenience, the interactive patriotic flag toy 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flag display device comprising:
an ergonomic handle;
a flag member;
a rotation member; and
an illumination member;
wherein said illumination member having a plurality of LEDs embedded in said flag member for selective illumination of at least a first pattern and a first color of said flag member;
wherein said flag member rotatably coupled to a top end of said handle using said rotation member; and
further wherein said flag member having a material selected from the group consisting of a fabric and a plastic.

2. The flag display device of claim 1, wherein said flag member having curved ends.

3. The flag display device of claim 2, wherein said at least a first pattern and a first color replicates a first country flag.

4. The flag display device of claim 2, wherein said at least a first pattern and a first color selected from the group consisting of a country's flag, a state's flag, a team's flag, and an event's flag.

5. The flag display device of claim 4, wherein said rotation member selectively actuated for rotating said flag member.

6. The flag display device of claim 5 further comprising an audio member and a speaker for playing out a selected at least a first audio.

7. The flag display device of claim 6, wherein said at least first audio associated with said at least first pattern and a first color to match a theme of said at least first pattern and a first color.

8. The flag display device of claim 7, wherein said handle having an adhesive on a bottom end for securing said flag display device to a surface.

9. The flag display device of claim 1, wherein said illumination member having a plurality of LEDs embedded in said flag member for selective illumination of at least a second pattern and a second color of said flag member.

10. The flag display device of claim 9, wherein said at least a first pattern and a first color, and said at least a second pattern and said second color selected from the group consisting of a country's flag, a state's flag, a team's flag, and an event's flag.

11. A flag display device comprising:
an ergonomic handle;
a flag member;
a rotation member;
an audio member; and
an illumination member;
wherein said illumination member having a plurality of LEDs embedded in said flag member for selective illumination of at least a first pattern and a first color of said flag member;
wherein said flag member rotatably coupled to a top end of said handle using said rotation member;
wherein said flag member having a material selected from the group consisting of a fabric and a plastic;
wherein said audio member having a speaker for playing out a selected at least a first audio; and
further wherein said at least a first pattern and a first color selected from the group consisting of a country's flag, a state's flag, a team's flag, and an event's flag.

12. The flag display device of claim 11, wherein said flag member having curved ends.

13. The flag display device of claim 12, wherein said rotation member selectively actuated for rotating said flag member.

14. The flag display device of claim 13, wherein said at least first audio associated with said at least first pattern and a first color to match the theme of said first pattern and a first color.

15. The flag display device of claim 14, wherein said illumination member having a plurality of LEDs embedded in said flag member for selective illumination of at least a second pattern and a second color of said flag member.

16. The flag display device of claim 15, wherein said at least a first pattern and a first color, and said at least a second pattern and said second color selected from the group consisting of a country's flag, a state's flag, a team's flag, and an event's flag.

17. A flag display device comprising:
an ergonomic handle;
a flag member;
an audio member; and
an illumination member;
wherein said illumination member having a plurality of LEDs embedded in said flag member for selective illumination of at least a first pattern and a first color of said flag member;
wherein said flag member having a material selected from the group consisting of a fabric and a plastic;
wherein said at least a first pattern and a first color selected from the group consisting of a country's flag, a state's flag, a team's flag, and an event's flag;
wherein said audio member and a speaker for playing out a selected at least a first audio; and
further wherein said at least first audio associated with said at least first pattern and a first color to match the theme of said first pattern and a first color.

18. The flag display device of claim 17, wherein said illumination member having a plurality of LEDs embedded in said flag member for selective illumination of at least a second pattern and a second color of said flag member.
